(19) United States
(12) Patent Application Publication
(10) Pub. No.: US 2015/0365697 A1
(43) Pub. Date: Dec. 17, 2015

(54) IMAGE ENCODING METHOD AND IMAGE ENCODING APPARATUS

(71) Applicant: FUJITSU LIMITED, Kawasaki-shi (JP)

(72) Inventors: Jiangli YE, Beijing (CN); Xuan FU, Beijing (CN)

(73) Assignee: FUJITSU LIMITED, Kawasaki-shi (JP)

(21) Appl. No.: 14/732,912

(22) Filed: Jun. 8, 2015

(30) Foreign Application Priority Data
Jun. 11, 2014 (CN) 201410256987.3

(51) Int. Cl. H04N 19/593; G09G 3/00; G06T 7/40; H04N 19/186; H04N 19/182

(52) U.S. Cl. CPC H04N 19/593; H04N 19/186; H04N 19/182; G06T 7/408; G09G 3/007; G06T 2207/10024; G09G 2300/0452

(57) ABSTRACT

An image encoding method includes scanning each pixel in a CU, so as to record color values of color components of each pixel, selecting any color component from the color components as a reference color, and mapping color values of other color components in the color components into color values corresponding to the reference color, so that the color values of the color components are color values based on the reference color, generating a color index table according to the mapped color values of the color components, replacing the color values of the color components of the pixel with index values in the index table to which the color values of the color components of the pixel correspond, and performing entropy encoding on the CU according to the index table and an index value corresponding to each pixel.

### CROSS-REFERENCE TO RELATED APPLICATIONS

This application claims the benefit of Chinese Application No. 201410256987.3, filed Jun. 11, 2014, in the Chinese Intellectual Property Office, the disclosure of which is incorporated herein by reference.

### BACKGROUND

1. Field

The present disclosure relates to the field of image processing technologies, and in particular to an image encoding method and an image encoding apparatus.

2. Description of the Related Art

Image compression is used to reduce an amount of data that are needed in denoting digital images. The reason that images can be compressed is that redundancy exists in the data, and an object of data compression is to eliminate such data redundancy to lower a number of bits needed in denoting data. As the amount of the image data is bulky, and data storage, transmission and processing are hard-working, compression of image data becomes very important.

In conventional color encoding or palette encoding of complex images, respective index tables are used to compress three color components, that is, each color component corresponds to an index table.

There is a need for a new image encoding method, which is able to further lower the amount of data denoting images, thereby optimizing a compression effect.

### SUMMARY

Additional aspects and/or advantages will be set forth in part in the description which follows and, in part, will be apparent from the description, or may be learned by practice of the invention.

In view of the above, the present disclosure proposes a new image encoding technology, which uses only one index table to denote color components of three components, thereby further lowering the amount of data denoting images.

According to an aspect of the embodiments of the present disclosure, there is provided an image encoding method, including: scanning each pixel in a coding unit (CU), so as to record color values of color components of each pixel; selecting any color component from the color components as a reference color, and mapping color values of other color components in the color components into color values corresponding to the reference color, so that the color values of the color components are color values based on the reference color; generating a color index table according to the mapped color values of the color components; replacing the color values of the color components of the pixel with index values in the index table to which the color values of the color components of the pixel correspond; and performing entropy encoding on the CU according to the index table and an index value corresponding to each pixel.

According to an aspect of the embodiments of the present disclosure, there is provided an image encoding apparatus, including: a recording unit configured to scan each pixel in a coding unit (CU), so as to record color values of color components of each pixel; a mapping unit configured to select any color component from the color components as a reference color, and map color values of other color components in the color components into color values corresponding to the reference color, so that the color values of the color components are color values based on the reference color; a color index table generating unit configured to generate a color index table according to the mapped color values of the color components, and replace the color values of the color components of the pixel with index values in the index table to which the color values of the color components of the pixel correspond; and a compressing unit configured to perform entropy encoding on the CU according to the index table and an index value corresponding to each pixel.

According to a further aspect of the embodiments of the present disclosure, there is provided electronic equipment, including the image encoding apparatus as described above.

According to still another aspect of the embodiments of the present disclosure, there is provided a program product in which a machine-readable instruction code is stored, wherein when the program product is executed, the machine is enabled to carry out the above image encoding method.

According to still another aspect of the embodiments of the present disclosure, there is provided a computer-readable storage medium, in which the above program product is stored.

Scanning the CU so as to generate the index table in which index values of two pixel sets having symmetrical characteristics are identical according to the image encoding apparatus, image encoding method and electronic equipment can achieve at least one of the following advantages: reducing a number of index values, and lowering complexity of the index table, thereby further reducing an amount of data denoting images, which is particularly applicable to compression of computer-generated images or screenshot images.

These and other advantages of the present disclosure shall become more apparent with reference to the description of preferred embodiments of the present disclosure with reference to the accompanying drawings.

### BRIEF DESCRIPTION OF THE DRAWINGS

The present disclosure shall be better understood from the following description with reference to the accompanying drawings, in which identical or similar reference numbers are used throughout the drawings to represent identical or similar parts. The accompanying drawings together with the following detailed explanation are contained in the description and constitute a part of the present disclosure, and are used to further illustrate the preferred embodiments of the present disclosure and interpret the principle and advantages of the present disclosure. In the drawings:

FIG. 1 shows a flowchart of the image encoding method according to an embodiment of the present disclosure;

FIG. 2 is shows a flowchart of the image encoding method according to another embodiment of the present disclosure;

FIG. 3 is a schematic diagram of performing histogram counting on mapped color values according to an embodiment of the present disclosure; and

FIG. 4 shows a block diagram of the image encoding apparatus according to an embodiment of the present disclosure.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

In order that the above object, features and advantages of the present disclosure to be more clearly understood, the present disclosure shall be described below in details with reference to particular embodiments and the accompanying drawings. It should be noted that the embodiments of this application and the features in the embodiments may be combined each other without confliction.

Many details are described below for fully understanding the present disclosure. However, the present disclosure may be carried out in other manners than those described herein. Hence, the present disclosure is not limited to the particular embodiments disclosed below.

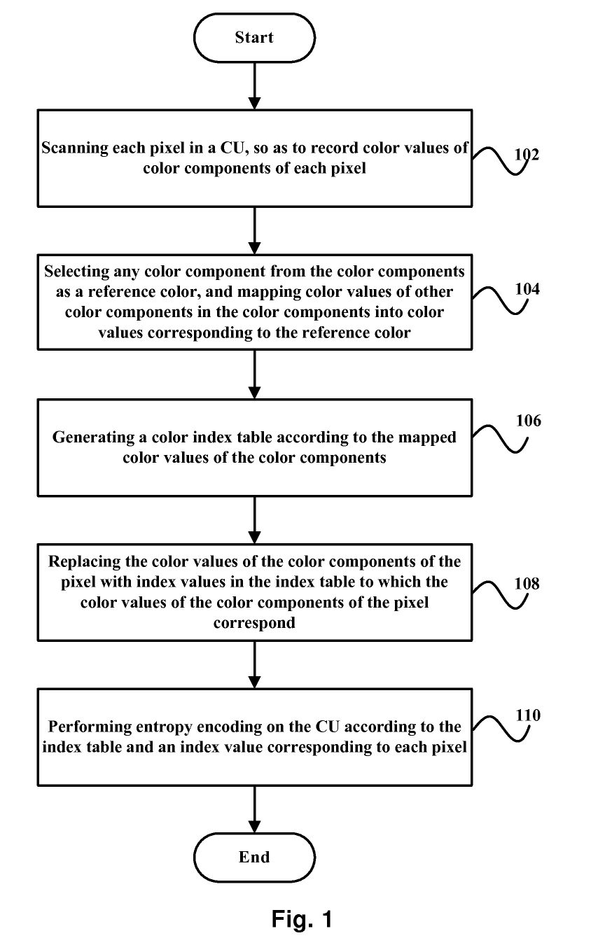

FIG. 1 shows a flowchart of the image encoding method according to an embodiment of the present disclosure.

As shown in FIG. 1, the image encoding method according to the embodiment of the present disclosure may include the operations of:

operation 102: scanning each pixel in a CU, so as to record color values of color components of each pixel;

operation 104: selecting any color component from the color components as a reference color, and mapping color values of other color components in the color components into color values corresponding to the reference color, so that the color values of the color components are color values based on the reference color;

operation 106: generating a color index table according to the mapped color values of the color components;

operation 108: replacing the color values of the color components of the pixel with index values in the index table to which the color values of the color components of the pixel correspond; and

operation 110: performing entropy encoding on the CU according to the index table and an index value corresponding to each pixel.

In operation 106, a process of generating the index table includes:

counting different mapped color values of the reference color, and allocating a unique index value for each different color value, so as to generate the color index table.

In particular, a manner of generating the index table may be:

performing histogram counting on the mapped color values of the reference color, and performing ordering according to a number of times of counting the color values of the reference color in the histogram; and

allocating a unique index value for each ordered color value of the reference color, so as to generate the color index table.

In order to further reduce an amount of data, a corresponding index value is used to denote each pixel value in the CU, so as to form a corresponding index value matrix; and the index value matrix is recompressed in a difference encoding or intra-prediction manner.

In the above technical solution, preferably, a rule for mapping color values of other color components in the color components into color values corresponding to the reference color is: calculating the color values of the other color components mapped onto the reference color according to a function relationship between the other color components and the reference color.

The function relationship may be Cb′(Y)=0.587Y+0.413Cb, Cr′(Y)=0.515Y+0.485Cr.

Use of the technical solution of the present disclosure may reduce a number of index values, and lower complexity of the index table, thereby further reducing an amount of data denoting images, which is particularly applicable to compression of computer-generated images or screenshot images.

For each pixel, description shall be give below taking three color components of Y, Cr and Cb as examples. It should be understood that processing of three color components of R, G and B is identical to this, which shall not be described herein any further.

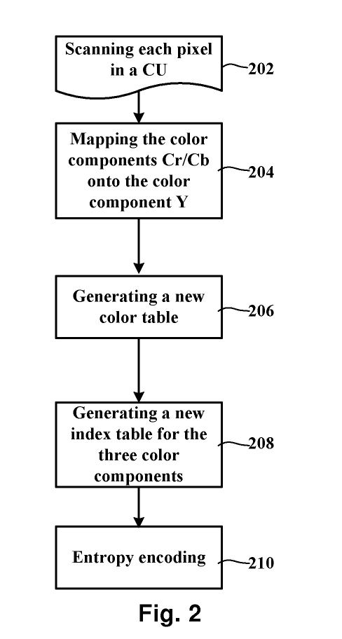

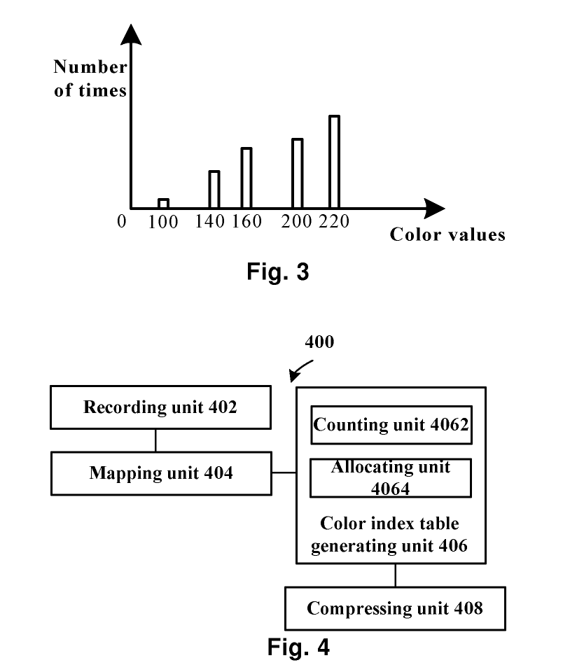

The image encoding method according to the embodiment of the present disclosure shall be described below with reference to FIG. 2.

As shown in FIG. 2, operation 202: scanning each pixel in a CU, so as to obtain particular color values of the three color components of each pixel;

operation 204: mapping the color components of Cr and Cb of each pixel onto the color component Y, so that the color values of the color components of Cr and Cb are color values based on the color value of the color component Y;

in mapping, a mapping rule may be determined as demanded, and mapping onto the color component Y is uniformly performed according to the mapping rule;

the mapping rule may be Cb′(Y)=0.587Y+0.413Cb, Cr′(Y)=0.515Y+0.485Cr; where, Y is the reference color, Cb and Cr are other two color components in the three color components, respectively, and Cb′(Y) and Cr′(Y) are color values of the color values of the other two color components mapped onto the reference color;
operation 206: generating a new color table after mapping, the three color components of each pixel being related to the reference color Y;

operation 208: counting the color values after mapping, and allocating an index value for each color value, so as to obtain a new index table, the index table being shared by the three color components;

operation 210: performing entropy encoding on the CU according to the index table after the index table is generated.

A corresponding index value is used to denote each pixel value in the CU, so as to form a corresponding index value matrix; and in order to further reduce an amount of compression, the index value matrix may be recompressed. Any existing manner of compression may be employed, such as a difference encoding or an inter-prediction encoding manner.

The above manner of mapping is only one of the examples. In addition to this, the color components Y and Cb may be mapped onto the color component Cr, or the color components Y and Cr may be mapped onto the color component Cb.

In the present disclosure, two color components may be mapped onto the other color components, and the three color components may be made to share an index table, thereby eliminating redundant data between the color components, and improving the compression efficiency.

The above processing flow of image encoding shall be described below in detail with reference to digits in tables.

Table 1 is an initial color index table of the color component Y, Table 2 is an initial color index table of the color component Cb, and Table 3 is an initial color index table of the color component Cr.

TABLE 1

| Index value | Color value |
|---|---|
| 0 | 100 |
| 1 | 140 |
| 2 | 200 |

TABLE 2

| Index value | Color value |
|---|---|
| 0 | 140 |
| 1 | 160 |
| 2 | 220 |

TABLE 3

| Index value | Color value |
|---|---|
| 0 | 100 |
| 1 | 200 |
| 2 | 220 |

In a conventional image encoding method, there exists a corresponding index table for each color component, as shown in the above three tables. Hence, redundant data between the color components are not reduced. In this embodiment, the redundant data between the color components are reduced, thereby further reducing an amount of data denoting images.

The color values of Cb shown in Table 2 and the color values of Cr shown in Table 3 are respectively mapped onto the color component Y, and a new Table 2 and a new Table 3 are obtained.

The histogram counting is performed on the mapped color values, and ordering is performed according to a number of times of counting the color values of the reference color in the histogram. For example, a counted number of times of occurrence of color value 100 is 1, a number of times of occurrence of color value 140 is 3, a number of times of occurrence of color value 160 is 5, a number of times of occurrence of color value 200 is 6, and a number of times of occurrence of color value 220 is 8, as shown in Table 3. Then a unique index value is allocated for each color value, so as to generate the color index table, as shown in Table 4 below.

TABLE 4

| Index value | Color value based on Y |
|---|---|
| 0 | 100 |
| 1 | 140 |
| 2 | 160 |
| 3 | 200 |
| 4 | 220 |

Above Table 4 is the generated index table that can be shared by the three color components. The entropy encoding is performed on the CU based on the new index table. Therefore, the prior art needs to use three index tables, while the image encoding technology according to the present disclosure needs only one index table, in which the redundant data between the color components are eliminated, and 9 color values need to be denoted previously, and now only 5 color values need only to be denoted. A number of needed bits is 3×3×8 (assuming that a number of bits occupied by each color value is 8) if the prior art is used, while a number of needed bits is 5×8 if the solution of the present disclosure is used, which is much lower than that of the prior art. Hence, the image encoding method according to the present disclosure may greatly increase image compression efficiency.

FIG. 4 shows a block diagram of the image encoding apparatus according to an embodiment of the present disclosure.

As shown in FIG. 4, the image encoding apparatus 400 according to the embodiment of the present disclosure may include:

a recording unit 402 configured to scan each pixel in a CU, so as to record color values of color components of each pixel;

a mapping unit 404 configured to select any color component from the color components as a reference color, and map color values of other color components in the color components into color values corresponding to the reference color, so that the color values of the color components are color values based on the reference color;

a color index table generating unit 406 configured to generate a color index table according to the mapped color values of the color components, and replace the color values of the color components of the pixel with index values in the index table to which the color values of the color components of the pixel correspond; and

a compressing unit 408 configured to perform entropy encoding on the CU according to the index table and an index value corresponding to each pixel.

Wherein, the color index table generating unit 406 counts different mapped color values of the reference color, and allocates a unique index value for each different color value, so as to generate the color index table.

Wherein, the color index table generating unit 406 includes:

a counting unit 4062 configured to perform histogram counting on the mapped color values of the reference color, and perform ordering according to a number of times of counting the color values of the reference color in the histogram; and

an allocating unit 4064 configured to allocate a unique index value for each ordered color value of the reference color, so as to generate the color index table.

And the compressing unit 408 is further configured to recompress the index value matrix in a difference encoding or intra-prediction manner; wherein, a corresponding index value is used to denote each pixel value in the CU, so as to form the corresponding index value matrix.

Wherein, a rule for mapping color values of other color components in the color components into color values corresponding to the reference color by the mapping unit 404 is: calculating the color values of the other color components mapped onto the reference color according to a function relationship between the other color components and the reference color.

Furthermore, an embodiment of the present disclosure provides electronic equipment, including the image encoding apparatus described above. In a particular implementation of the above electronic equipment according to the embodiment of the present disclosure, the above electronic equipment may be any one of the following devices: a computer, a tablet computer, a digital personal assistant, a multimedia playing device, a mobile phone, and an electronic book, etc. Wherein, the electronic equipment possesses the functions and technical effects of the above image encoding apparatus, which shall not be described herein any further.

The units, subunits and modules in the image encoding apparatus according to the embodiment of the present disclosure may be configured by software, hardware, firmware, or a combination thereof. In a case where they are carried out by software or firmware, a program constituting the software or firmware may be mounted from a storage medium or network to a machine having a specific hardware architecture, and when being mounted with various programs, the machine may execute the function of the above units and subunits.

Furthermore, the present disclosure proposes a program product in which a machine-readable instruction code is stored, wherein when the program product is read and executed by a machine, the machine is enabled to carry out the above image encoding method according to the embodiment of the present disclosure. Correspondingly, various storage media for carrying such a program product, such as a disc, a CD, a magneto-optical disk, and a semiconductor memory, are also covered by the present disclosure.

Furthermore, the methods of the embodiments of the present disclosure are not limited to be carried out in the order described in the description or shown in the drawings, and may also be carried out in parallel or separately in other temporal orders. Therefore, the orders of carrying out the method described in the description do not limit the technical scope of the present disclosure.

Furthermore, it is obvious that the operational processes of the above method according to the present disclosure may also be carried out by computer-executable programs stored in various machine-readable storage media.

And the object of the present disclosure may also be achieved in the following manner: proving the storage medium in which the above executable program code directly or indirectly to a system or equipment, and a computer or a central processing unit in the system or equipment reads and executes the above program code.

At this moment, only if the system or equipment possesses a function of executing a program, an implementation of the present disclosure is not limited to a program, and the program may also be in any form, such as an object program, an interpreter-executed program, or a script program provided to an operating system, etc.

The above machine-readable storage media include but not limited to various memories and storage units, semi-conductor devices, disk units, such as a disc, a CD, and a magneto-optical disk, and other media suitable for storing information, etc.

The technical solution according to the present disclosure is described above with reference to the drawings. In the present disclosure, two color components are mapped onto the other color component, and the three color components can share an index table, thereby eliminating the redundant data between the color components, and improving the compression efficiency.

What described above are preferred embodiments of the present disclosure only, and are not intended to limit the present disclosure. Various modifications and variations may be made by those skilled in the art. Any modifications, equivalents and improvement made within the spirits and principle of the present disclosure shall be covered by the protection scope of the present disclosure.

In summary, in the embodiments according to the present disclosure, the present disclosure provides the following solution but not limited thereto:

Supplement 1. An image encoding method, including:

scanning each pixel in a CU, so as to record color values of color components of each pixel;

selecting any color component from the color components as a reference color, and mapping color values of other color components in the color components into color values corresponding to the reference color, so that the color values of the color components are color values based on the reference color;

generating a color index table according to the mapped color values of the color components;

replacing the color values of the color components of the pixel with index values in the index table to which the color values of the color components of the pixel correspond; and

performing entropy encoding on the CU according to the index table and an index value corresponding to each pixel.

Supplement 2. The image encoding method according to supplement 1, wherein different mapped color values of the reference color are counted, and a unique index value is allocated for each different color value, so as to generate the color index table.

Supplement 3. The image encoding method according to supplement 2, wherein histogram counting is performed on the mapped color values of the reference color, and ordering is performed according to a number of times of counting the color values of the reference color in the histogram;

and a unique index value is allocated for each ordered color value of the reference color, so as to generate the color index table.

Supplement 4. The image encoding method according to supplement 1, wherein a corresponding index value is used to denote each pixel value in the CU, so as to form a corresponding index value matrix;

and the index value matrix is recompressed in a difference encoding or intra-prediction manner.

Supplement 5. The image encoding method according to any one of supplements 1-4, wherein a rule for mapping color values of other color components in the color components into color values corresponding to the reference color is: calculating the color values of the other color components mapped onto the reference color according to a function relationship between the other color components and the reference color.

Supplement 6. The image encoding method according to supplement 5, wherein the function relationship is:

Cb′(Y)=0.587Y+0.413Cb, Cr′(Y)=0.515Y+0.485Cr; where, Y is the reference color, Cb and Cr are other two color components in the three color components, respectively, and Cb′(Y) and Cr′(Y) are color values of the color values of the other two color components mapped onto the reference color.

Supplement 7. An image encoding apparatus, including:

a recording unit configured to scan each pixel in a CU, so as to record color values of color components of each pixel;

a mapping unit configured to select any color component from the color components as a reference color, and map color values of other color components in the color components into color values corresponding to the reference color, so that the color values of the color components are color values based on the reference color;

a color index table generating unit configured to generate a color index table according to the mapped color values of the color components, and replace the color values of the color components of the pixel with index values in the index table to which the color values of the color components of the pixel correspond; and

a compressing unit configured to perform entropy encoding on the CU according to the index table and an index value corresponding to each pixel.

Supplement 8. The image encoding apparatus according to supplement 7, wherein the color index table generating unit is configured to count different mapped color values of the reference color, and allocate a unique index value for each different color value, so as to generate the color index table.

Supplement 9. The image encoding apparatus according to supplement 8, wherein the color index table generating unit includes:

a counting unit configured to perform histogram counting on the mapped color values of the reference color, and perform ordering according to a number of times of counting the color values of the reference color in the histogram; and

an allocating unit configured to allocate a unique index value for each ordered color value of the reference color, so as to generate the color index table.

Supplement 10. The image encoding apparatus according to supplement 7, wherein the compressing unit is further configured to recompress the index value matrix in a difference encoding or intra-prediction manner; and wherein a corresponding index value is used to denote each pixel value in the CU, so as to form the corresponding index value matrix.

Supplement 11. The image encoding apparatus according to any one of supplements 7-10, wherein a rule for mapping color values of other color components in the color components into color values corresponding to the reference color by the mapping unit is: calculating the color values of the other color components mapped onto the reference color according to a function relationship between the other color components and the reference color.

Supplement 12. The image encoding apparatus according to supplement 11, wherein the function relationship is:

Cb′(Y)=0.587Y+0.413Cb, Cr′(Y)=0.515Y+0.485Cr; where, Y is the reference color, Cb and Cr are other two color components in the three color components, respectively, and Cb′(Y) and Cr′(Y) are color values of the color values of the other two color components mapped onto the reference color.

Supplement 13. Electronic equipment, including the image encoding apparatus as described in any one of supplements 7-12.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An image encoding method, comprising:
scanning each pixel in a coding unit (CU), and recording color values of color components of each pixel;
selecting any color component from the color components as a reference color, and mapping color values of other color components in the color components into color values corresponding to the reference color, so that the color values of the other color components are color values based on the reference color;
generating a color index table according to the mapped color values of the other color components and the reference color;
replacing the color values of the color components of the each pixel with index values in the index table to which the color values of the color components of the pixel correspond; and
performing entropy encoding on the CU according to the index table and an index value corresponding to the each pixel.

2. The image encoding method according to claim 1, wherein different mapped color values of the reference color are counted, and a unique index value is allocated for each different color value, so as to generate the color index table.

3. The image encoding method according to claim 2, wherein histogram counting is performed on the mapped color values of the reference color, and ordering is performed according to a number of times of counting the color values of the reference color in the histogram; and
a unique index value is allocated for each ordered color value of the reference color, so as to generate the color index table.

4. The image encoding method according to claim 1, wherein a corresponding index value is used to denote each pixel value in the CU, so as to form a corresponding index value matrix; and
the index value matrix is recompressed in a difference encoding or intra-prediction manner.

5. The image encoding method according to any one of claims 1-4, wherein a rule for mapping color values of other color components in the color components into color values corresponding to the reference color is:
calculating the color values of the other color components mapped onto the reference color according to a function relationship between the other color components and the reference color.

6. An image encoding apparatus, comprising:
a recording unit configured to scan each pixel in a CU, and record color values of color components of each pixel;
a mapping unit configured to select any color component from the color components as a reference color, and map color values of other color components in the color components into color values corresponding to the reference color, so that the color values of the other color components are color values based on the reference color;
a color index table generating unit configured to generate a color index table according to the mapped color values of the other color components and the reference color, and replace the color values of the color components of the each pixel with index values in the index table to which the color values of the color components of the pixel correspond; and
a compressing unit configured to perform entropy encoding on the CU according to the index table and an index value corresponding to the each pixel.

7. The image encoding apparatus according to claim 6, wherein the color index table generating unit is configured to count different mapped color values of the reference color, and allocate a unique index value for each different color value, so as to generate the color index table.

8. The image encoding apparatus according to claim 7, wherein the color index table generating unit comprises:
a counting unit configured to perform histogram counting on the mapped color values of the reference color, and perform ordering according to a number of times of counting the color values of the reference color in the histogram; and
an allocating unit configured to allocate a unique index value for each ordered color value of the reference color, so as to generate the color index table.

9. The image encoding apparatus according to claim 6, wherein the compressing unit is further configured to recompress the index value matrix in a difference encoding or intra-prediction manner; and wherein a corresponding index value is used to denote each pixel value in the CU, so as to form the corresponding index value matrix.

10. The image encoding apparatus according to claims 6-9, wherein a rule for mapping color values of other color components in the color components into color values corresponding to the reference color by the mapping unit is:
calculating the color values of the other color components mapped onto the reference color according to a function relationship between the other color components and the reference color.

11. An image encoding method, comprising:
recording a color value of a color component of each of a plurality of pixels;
selecting a reference color component from the color components as a reference color;
mapping each of the color values in the color components other than the reference color component into color values corresponding to the reference color, so that the color values of the other color components are color values based on the reference color;
generating a color index table according to the mapped color values of the other color components and the reference color;
replacing the color values of the color components of each of the plurality of pixels with index values in the index table to which the color values of the color components of each of the plurality of pixels correspond; and
performing entropy encoding on the CU according to the index table and an index value corresponding to the each pixel.
